(19) United States
(12) Patent Application Publication
(10) Pub. No.: US 2006/0250357 A1
(43) Pub. Date: Nov. 9, 2006

(54) Mode manager for a pointing device

(76) Inventor: Mammad Safai, Los Altos, CA (US)

Correspondence Address: AVAGO TECHNOLOGIES, LTD., P.O. BOX 1920, DENVER, CO, 80201-1920, US

(21) Appl. No.: 11/121,813

(22) Filed: May 4, 2005

(51) Int. Cl. G09G 5/00; G09G 5/08

(52) U.S. Cl. 345/157

(57) ABSTRACT

A portable electronic device comprises a pointing device and a mode manager. The pointing device is configured to detect relative movement across a surface. The mode manager is configured to switch between a first mode of operation of the pointing device and a second mode of operation of the pointing device based on a parameter associated with pointing device and/or the portable electronic device.

### BACKGROUND

A pointing device is typically used for controlling the position of a cursor or pointer on a display, such as a computer display. For desktop personal computers (PC's), a commonly used pointing device is the mouse. A mouse is a hand held object that is moved over a flat surface near the keyboard to control the motion of a cursor on the computer display. The direction and distance over which the mouse is moved determines the direction and distance the cursor moves on the display.

While the mouse has provided a satisfactory solution to the pointing device problem in the desktop PC market, a similarly successful device is not available for portable and hand-held computers, and other portable electronic devices. For portable electronic devices, such as laptop computers, cellular telephones, personal digital assistants (PDAs), digital cameras, portable game devices, pagers, portable music players (e.g., MP3 players), and other devices, it may be undesirable to use an external pointing device, such as a mechanical mouse or an optical mouse, coupled to the device. It is often inconvenient to carry around the additional equipment, and these portable electronic devices are often used in environments that lack a sufficiently large flat surface over which a mouse can be moved.

Currently, there are two dominant solutions to the pointing device problem in the laptop marketplace, which are the Synaptics capacitive TouchPad™ and the IBM TrackPoint™. Other companies make versions of these devices with similar functionality. The TrackPoint™ is a small button that is typically placed in the center of the laptop keyboard. The button may be moved in a manner analogous to a joystick by applying a lateral force to the top of the button with a finger. Typical joystick pointing devices cause continued movement of the cursor across a screen when the joystick mechanism meets a lateral boundary of movement of the joystick. These types of devices enable high-speed movements of a cursor or other screen-related objects, but with less precision than a mouse-type pointing device.

The TouchPad™ is a blank rectangular pad, typically 50-100 mm on a side, and typically placed in front of the keyboard of most laptops. The device senses the position of a finger on the surface of the rectangle relative to the edges of the device. In a typical touchpad-type device, the cursor stops on the screen when the position of the finger reaches the edge of the device. These types of devices enable precise, fine movements that one would expect with a conventional mouse-type pointing device.

Each type of pointing device has its advantages and its disadvantages relating to size, speed, cost, precision, accuracy, etc. Accordingly, the type of pointing device for a given portable electronic device limits the performance of the portable electronic device according to those advantages and disadvantages.

### SUMMARY

Embodiments of the invention are directed to pointing device. In one embodiment, a portable electronic device comprises a pointing device and a mode manager. The pointing device is configured to detect relative movement at a portion of the pointing device. The mode manager is configured to switch between a first mode of operation of the pointing device and a second mode of operation of the pointing device based on a parameter associated with the pointing device and/or the portable electronic device.

### BRIEF DESCRIPTION OF THE DRAWINGS

FIG. 1A is diagram illustrating a top view of a pointing device according to an embodiment of the present invention.

FIG. 1B is a diagram illustrating a cross-sectional view along section line 1B-1B of the pointing device shown in FIG. 1A according to an embodiment of the present invention.

FIG. 2 is diagram illustrating a top view of a portion of the surface shown in FIG. 1A over which the puck moves according to an embodiment of the present invention.

FIG. 3 is a diagram illustrating an equivalent circuit for the electrodes shown in FIG. 2 according to an embodiment of the present invention.

FIG. 4 is a diagram illustrating a top plan view of a portable electronic device, according to an embodiment of the present invention.

FIG. 5 is a block diagram illustrating a pointing device and host device, according to an embodiment of the present invention.

FIG. 6 is a diagram illustrating modes of operation of a pointing device, according to an embodiment of the present invention.

FIG. 7 is block diagram of a mode manager, according to an embodiment of the present invention.

FIG. 8 is a flow diagram of method of managing modes of operation of a pointing device, according to an embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

Embodiments of the invention are directed to pointing devices and/or portable electronic devices including pointing devices. In particular, embodiments of the invention enable switching between different modes of operation for a pointing device depending upon one or more parameters of the pointing device and/or portable electronic device. In one embodiment, a pointing device is operated in a first mode resembling a mouse-type behavior and in a second mode resembling a joystick-type behavior. Switching between the first mode and the second mode is based on one or more parameters such as the type of application of the portable electronic device, such as gaming, menu navigation, word processing, web browsing, etc. Other parameters that drive switching modes of operation for a pointing device relate to aspects of relative movement at a portion of the pointing device, such as a sliding action, pressing action, rolling action, etc. In particular, these parameters include a position, speed, pressure, duration, and/or distance associated with relative movement at the portion of the pointing device. In one embodiment, the parameter includes a position, speed, pressure, duration, and/or distance associated with movement of a finger or puck relative to a base surface of a pointing device.

Embodiments of the invention enable use of a single pointing device in one mode of operation for one purpose, such as speed and gross movement as in gaming, and in another different mode of operation for another purpose, such as precision and fine movements, as in graphics or text editing. In other embodiments, switching between different modes of operation for pointing devices are applied to more than one. pointing device associated with a host electronic device.

In one embodiment, an application operating on a host electronic device commands or directs a pointing device to operate in a selected mode, or to switch from one mode of operation to another. In this arrangement, firmware supporting the pointing device comprises a plurality of modes of operation for the pointing device, and the application (operating on the host electronic device) simply selects or commands which of those modes of operation will control the pointing device at a given point in time. In other words, the application (operating on the host electronic device) controls which mode of operation is running for the pointing device independent of, or in lieu of, a mode manager of the pointing device. In another aspect, the application (operating on the host electronic device) implements its selected mode of operation for the pointing device via a manager of the pointing device, with the application controlling the manager to determine the mode of operation.

In another embodiment, firmware supporting the pointing device comprises a plurality of modes of operation for the pointing device and also comprises a mode manager for controlling the switching of the modes of operation. In this embodiment, the mode manager bases its selection of a mode of operation on different parameters, including but not limited to a nature of an application operating on a host electronic device, manner of use of the pointing device, etc. However, in this arrangement, the mode manager determines which mode of operation is selected by using data regarding a nature (e.g., characteristics) of the application as only one input (of potentially multiple inputs) to the determination by the mode manager of which mode of operation to select. The nature of the application is communicated from the host electronic device to the pointing device to enable the mode manager to learn the nature of the application operating on the host electronic device. Accordingly, in this embodiment, an aspect of the mode manager determines the mode of operation of the pointing device rather than the application of the host electronic device directly determining/selecting the mode of operation of the pointing device. In one embodiment, operating a pointing device in more than one mode of operation is achieved via a pointing device comprising a base surface, a moveable puck, and a position detector. The moveable puck is confined to move over the base surface within a puck field of motion and the position detector identifies a position of the puck. Relative movement between the puck and the base surface generates movement data to produce a corresponding movement of a cursor (or other graphical element) on a display screen.

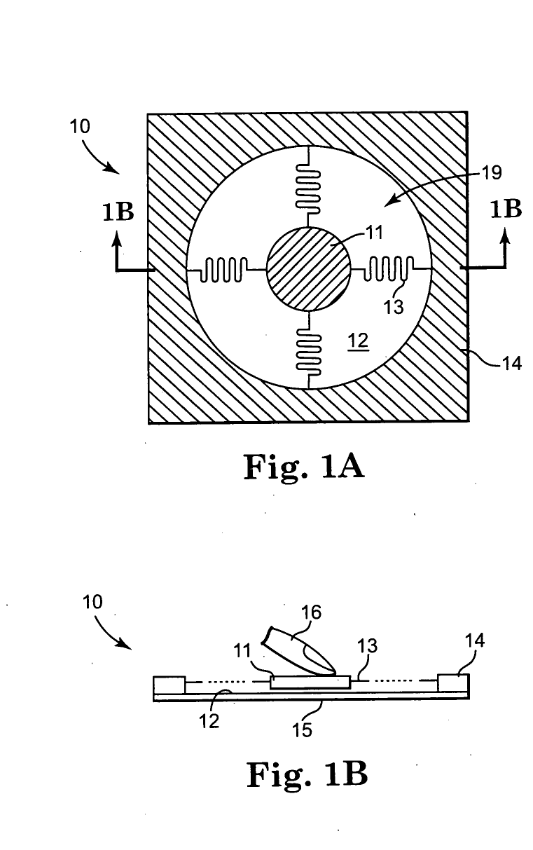

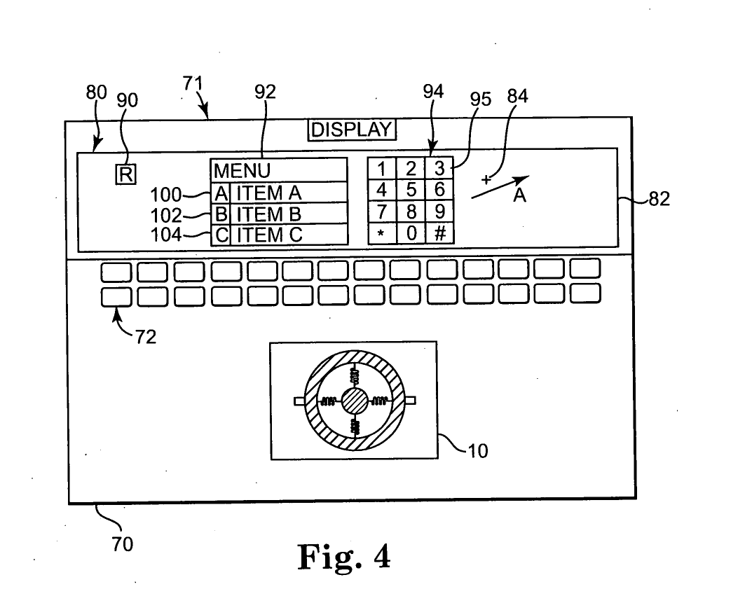

One example of a pointing device is described and illustrated in association with FIGS. 1A-3 as a foundation to a further description and illustration of embodiments of the invention in FIGS. 4-8 relating to managing modes of operation of a pointing device. However, other embodiments of the invention include pointing devices that identify or detect relative movement at a portion (e.g., a surface) of the pointing device based on properties relating to impedance, induction, magnetism, optics, and/or capacitance. Other types of pointing devices suitable for application with embodiments of the invention include but are not limited to, Touchpad™ devices, rockerswitch devices, trackball devices, scroll wheel devices, mouse-type devices, etc.

FIG. 1A is diagram illustrating a top view of a pointing device 10 according to one embodiment of the present invention. FIG. 1B is a diagram illustrating a cross-sectional view along section line 1B-1B of the pointing device 10 shown in FIG. 1A according to one embodiment of the present invention. As shown in FIGS. 1A and 1B, pointing device 10 includes a puck 11 that moves over a surface 12 of a substrate 15 within a circular puck field of motion 19 in response to a lateral force applied to puck 11. The force is typically applied to puck 11 by a user's finger, fingertip, thumb, thumb tip or multiple fingers. Puck 11 includes a pressure sensing mechanism that measures the vertical pressure applied to puck 11. In addition, pointing device 10 includes a sensing mechanism for determining the position of puck 11 on surface 12.

When the user applies a vertical force to puck 11 that is greater than a predetermined threshold, any change in the position of puck 11 on surface 12 is reported to a host apparatus of which pointing device 10 forms a part. This change in position is used to move a cursor on a display of the host apparatus by a magnitude and a direction that depend on the magnitude and direction of the motion of puck 11 while the vertical force was applied to puck 11.

When the user releases puck 11 by removing the user's finger 16, puck 11 is returned to its centered position by the springs 13 that connect the puck 11 to the side 14 of the puck field of motion 19. Since the user's finger 16 is not applying a vertical force to puck 11 during its return, the change in position associated with that return motion is not reported to the host device. That is, the cursor remains at its current location. This provides a convenient “re-centering” capability, typically achieved on a mouse by lifting and replacing the mouse at the center of the field of motion. Re-centering is particularly important in laptop computers, hand-held devices and other miniature applications in which the field of motion is constrained.

In one preferred embodiment of the present invention, the pressure sensor in puck 11 senses two predetermined pressure levels. The first level is used to actuate the tracking of the cursor on the display as described above. The second level is used to implement the click function associated with a conventional mouse. Hence, the user can click at the current position of the cursor by increasing the pressure applied to puck 11. A mechanical click can also be implemented to provide tactile feedback for the “click” threshold.

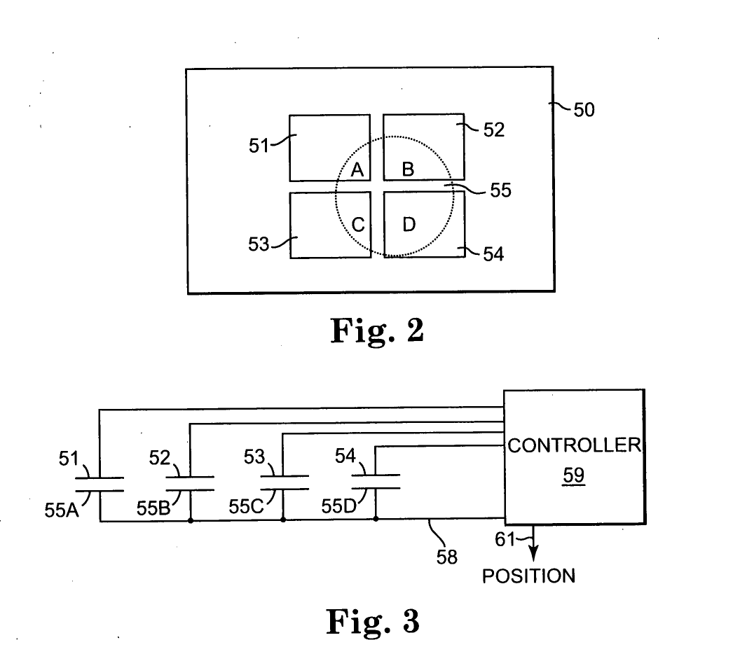

An embodiment of a position detector that detects the position of the puck 11 on the underlying surface 12 may be more easily understood with reference to FIG. 2. FIG. 2 is diagram illustrating a top view of a portion 50 of the surface 12 shown in FIG. 1A over which the puck 11 moves according to one embodiment of the present invention. Surface 50 includes four electrodes 51-54 having terminals that are connected to an external circuit. To simplify the drawing, these terminals have been omitted. The puck 11 has a bottom surface that includes an electrode 55 that is shown in phantom in the drawing. Electrodes 51-55 are electrically isolated from one another. For example, electrode 55 can be covered with a layer of dielectric that provides insulation, while still allowing electrode 55 to slide over the other electrodes 51-54. The overlap between electrode 55 and each of electrodes 51-54 depends on the position of the puck 11 relative to electrodes 51-54. The overlaps between electrode 55 and electrodes 51-54 are identified in FIG. 2 by the letters A-D, respectively.

FIG. 3 is a diagram illustrating an equivalent circuit for the electrodes 51-55 shown in FIG. 2 according to one embodiment of the present invention. The portions of electrode 55 that overlap electrodes 51-54 are represented by electrodes 55A-55D, respectively, in FIG. 3. The portion of electrode 55 that overlaps electrode 51 forms a parallel plate capacitor having a capacitance that is proportional to overlap A. Similarly, the portion of electrode 55 that overlaps electrode 52 forms a parallel plate capacitor that has a capacitance that is proportional to overlap B, and so on. Since all of the capacitors share portions of electrode 55, the equivalent circuit consists of four capacitors connected to a common electrode shown at 58. This electrode 58 corresponds to electrode 55 in FIG. 2. By measuring the capacitance between electrode 55 and each of electrodes 51-54, the position of electrode 55 (and correspondingly puck 11) relative to electrodes 51-54 can be determined. In one embodiment, this position determination is made by a controller 59, which may be part of the pointing device 10, or part of the host device of which the pointing device 10 forms a part. In one embodiment, controller 59 outputs two-dimensional position information via input/output line 61, which identifies the current position of the puck 11.

In embodiments in which the puck field of motion 19 is substantially greater than the diameter of the puck 11, more than four electrodes can be placed on the substrate 15. Capacitance measurements between each of these electrodes and the puck 11 can be used to determine the puck position as described above.

It will be understood by a person of ordinary skill in the art that functions performed by controller 59 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

In one embodiment, controller 59 also comprises a mode manager for controlling different modes of operation for a pointing device, such as pointing device 10, as will be further described in association with FIGS. 4-8.

A pointing device according to one embodiment of the present invention can be implemented as a stand-alone pointing device that replaces a conventional mouse. Embodiments of the present invention are also particularly well suited for implementation on a laptop computer or other host apparatus having limited space for a pointing device. FIG. 4 is a diagram illustrating a top view of a portable electronic device 70 having a pointing device 10 according to one embodiment of the present invention. In one embodiment, portable electronic device 70 is a laptop computer. In other embodiments, device 70 may be any type of portable electronic device having a display screen/area, including but not limited to a cellular/wireless telephone, personal digital assistant (PDA), digital camera, portable game device, pager, portable music player, and handheld computer.

As shown in FIG. 4, device 70 comprises pointing device 10, display 71, and keyboard 72. Display 71 comprises screen 80 including edge of screen 82 and cursor 84. Display 71 further comprises one or more elements of a graphical user interface (GUI) including, but not limited to icon 90, menu 92, and keypad 94. Menu 92 comprises first item 100, second item 102, and third item 104 arranged in a list. Keypad 94 comprises one or more activatable keys 95 representing numbers, letters, or other symbols. In other embodiments, cursor 84 comprises different shaped objects such as pointers, cartoon-type characters, etc.

A pointing device is operable in different modes to enable optimal performance depending upon the type of application, the type of user interface, conditions of use, etc. of a host electronic device associated with the pointing device. For example, one mode of operation includes a rockerswitch mode that is employed for navigating menu 92, including selecting one of items 100-104 for activation. In another example, a keypad mode of operation is employed for use of keypad 94, including navigating among keys 95 and activation of key(s) 95. Another mode of operation includes a mouse mode of operation and/or a joystick mode of operation to enable optimal control of cursor 84. Accordingly, to optimize the features of a pointing device (e.g., pointing device 10), a mode manager switches between these different modes of operation as different aspects of the pointing device are used and/or as different aspects of the host electronic device are used. These aspects, and additional aspects of embodiment of the invention, are further described and illustrated in association with FIGS. 5-8.

FIG. 5 is a block diagram of a pointing device and an associated host device that is used with the pointing device. As shown in FIG. 5, host device 70 comprises a consumer or portable electronic device including a phone 120, portable audio device 124 such as a MP3 player, camera 126, personal digital assistant 126, universal remote 128, global positioning satellite device 130, and portable computer 132, such as a laptop or handheld computer.

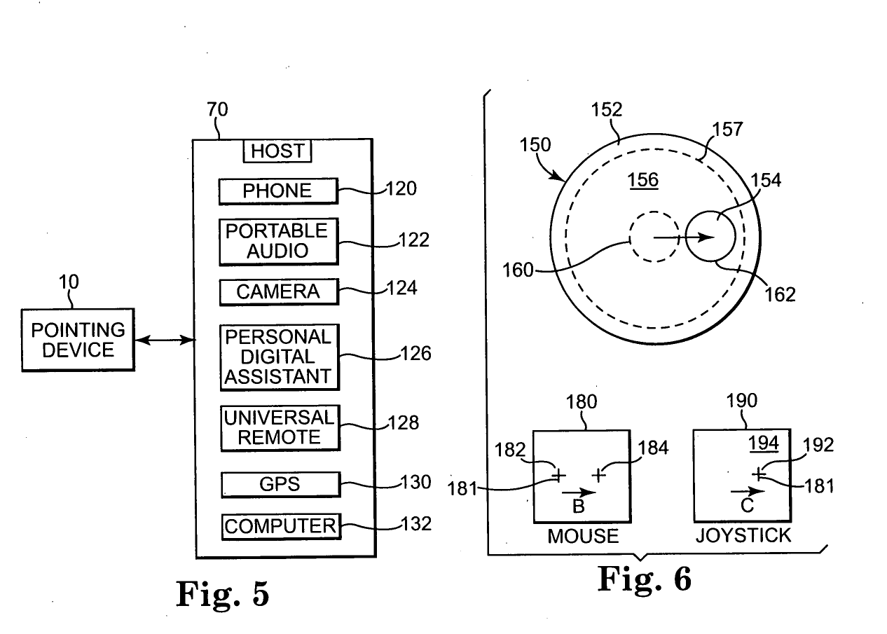

FIG. 6 is a diagram illustrating a pointing device 150, according to an embodiment of the invention. In one embodiment, pointing device 150 has substantially the same features and attributes as pointing device 10.

As shown in FIG. 6, pointing device 150 comprises base surface 152, puck 154, and a field of motion 156. An outer boundary of field of motion 156 is defined by generally circular edge 157. However, edge 157 is not limited to a generally circular shape. Dashed circle 160 represents a center of the base surface 152 to which puck 154 is returned during operation, according to a re-centering mechanism or restoring mechanism as previously described in association with FIGS. 1A-3. Solid lined circle 162 shown in FIG. 6 represents a current position of puck 154 within field of motion 156. In this example, puck 154 is positioned immediately adjacent edge 157 of field of motion 156.

FIG. 6 also shows display screen 180 and display screen 190, which represent a single display device (e.g., display 71 in FIG. 4) seen at two different points in time to illustrate use of pointing device 150 in two different modes of operation. In one embodiment, pointing device 150 is used in a first mode of operation, which corresponds to display screen 180 and a second mode of operation, which corresponds to display screen 190. In one embodiment, display screen 180 shows pointing device 150 in a mouse-type mode of operation and display screen 190 shows pointing device 150 in a joystick-type mode of operation. A mouse-type mode of operation comprises pointing device 150 producing cursor movements substantially the same as would be produced by a conventional mouse. A joystick-type mode of operation comprises pointing device 150 producing cursor movements substantially the same as would be produced by a conventional joystick.

As further shown in FIG. 6, display screen 180 includes a cursor 181 at a first position 182 and a second position 184 with directional arrow B indicating movement from first stationary position 182 to second stationary position 184. A display screen 190 includes an area 194 on which cursor 192 (or other graphical object) moves in the direction indicated by arrow C. This arrangement represents the appearance of cursor 192 continuously moving in direction B relative to area 194, as one would expect in a gaming application where cursor 192 (or other object) in intermittent periods of continuous motion.

In a first mode of operation of pointing device 150, when puck 154 is held in the position shown at edge 157 of field of motion 156, cursor 181 remains at position 184. In a second mode of operation of pointing device 150, when puck 154 is held in the position shown at edge 157 of field of motion 156, cursor 181 keeps moving relative to area 194. In one aspect, in the second mode of operation, cursor 181 moves entirely off screen 190. Accordingly, in the second mode of operation, placement of puck 154 at the edge of field of motion of pointing device 150 does not result in stopping of cursor 181, but rather continued motion of cursor 181.

In another embodiment, movements of puck 154 adjacent center 160 are governed by a mouse mode of operation via mouse parameter 280 while movements of puck 154 adjacent edge 157 of field of motion 156 are governed by a joystick mode of operation via joystick parameter 282. Control is automatically switched via a mode manager from the mouse mode operation to the joystick mode of operation at a midpoint (or some other selected point) between the center 160 and edge 157. This arrangement enables fine, precision control at a center area within field of motion 156 and faster, less precise control at an edge of field of motion 156.

Embodiments of the invention for switching between different modes of operation for a pointing device are not limited to the pointing device 10, 150 of a puck and base surface arrangement. Instead, embodiments of the invention for switching between modes of operation include other types of pointing devices that incorporate sliding action, pressing action, rolling action, rocking action, etc, at some portion of the pointing device for producing cursor movements on a display screen.

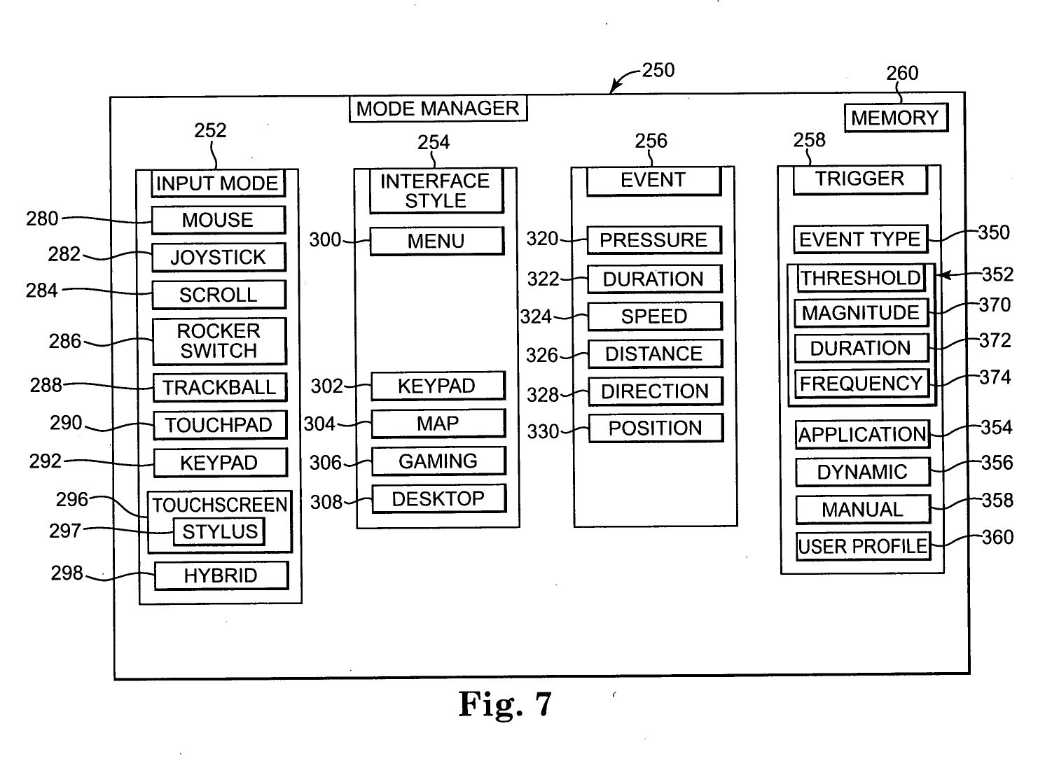

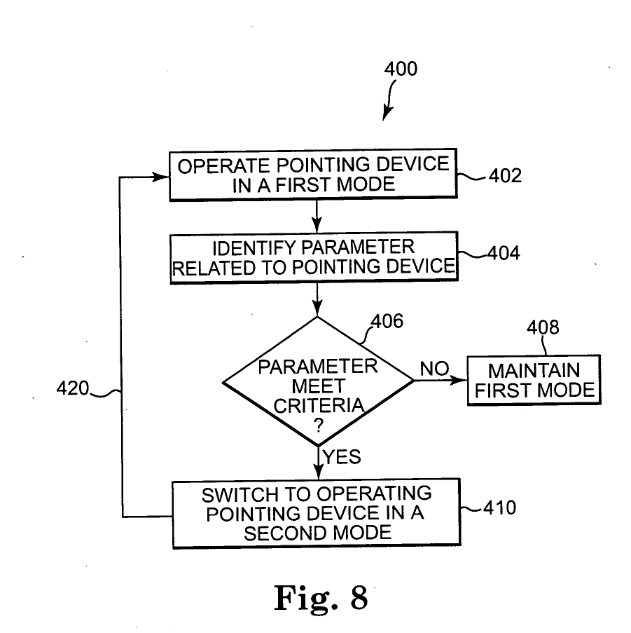

Parameters, including condition, events, etc. associated with pointing devices 10, 150 (and consumer electronic devices 120-132) that cause switching between the two different modes of operation are described and illustrated in association with FIGS. 7-8.

FIG. 7 is a block diagram of a mode manager 250, according to one embodiment of the invention. Mode manger 250 enables controlling different modes of operation for a pointing device, including but not limited to pointing device 10, 150. In one embodiment, mode manager 250 comprises a portion of controller 59 (FIG. 3) or is in communication with controller 59 to affect the operation of pointing device 10, 150.

As shown in FIG. 7, mode manager 250 comprises an input mode module 252, an interface style module 254, an event module 256, a trigger module 258, and a memory 260.

Input module 252 determines different modes of operation of pointing device 10, 150 via selection of one or more parameters identified in input module. Each parameter generally corresponds to an aspect of a conventional navigation input device. The parameter that controls a mode of operation of pointing device at any given point in time is selected according to operation of one or more of interface style module 254, event module 256, and trigger module 258 of mode manager 250.

As shown in FIG. 7, input module 252 comprises mouse parameter 280, joystick parameter 282, scroll parameter 284, rocker switch parameter 286, trackball parameter 288, touchpad parameter 290, keypad parameter 292, touchscreen parameter 296, stylus parameter 297, and hybrid parameter 298.

Mouse parameter 280 enables use of a pointing device in a conventional mouse mode while joystick parameter 282 enables use of a pointing device in a conventional joystick mode, both of which were previously described in association with FIG. 6 in accordance with one embodiment of the invention. For example, if mouse parameter 280 is enabled, when the sliding movements of the pointing device meet an edge of the range of motion of the pointing device (e.g., an edge of a sliding surface), then the mouse parameter 280 causes the cursor on the display screen to cease at the last point of movement and remain stationary until or unless the pointing device is recentered to enable further sliding movements. However, if joystick parameter 280 is enabled, when the sliding movements of the pointing device meet an edge of the range of motion of the pointing device (e.g., an edge of a sliding surface), then the joystick parameter 280 causes the cursor on the display screen to continue beyond the edge of the display screen or be shown as continued traveling motion relative to a moving background on the display screen.

In one embodiment, mouse parameter 280 and joystick parameter 282 also comprise additional aspects of conventional mouse-like behavior and conventional joystick-like behavior, respectively, for operation of a pointing device.

Scroll parameter 284 enables use of a pointing device in a scroll function, in which relative movements across the surface (e.g., sliding action) or relative movements against the surface (e.g., pressing action) of the pointing device cause a scrolling action of a cursor, list, spreadsheet, text, etc. vertically or horizontally across a display screen associated with the pointing device.

Rocker switch parameter 284 enables use of a pointing device in a menu selection function, in which relative movements across the surface (e.g., sliding action) or relative movements against the surface (e.g., pressing action) of the pointing device cause vertical or horizontal movements across a display screen associated with the pointing device. A single pressing action of the pointing device generally corresponds to a single discrete movement of a cursor (or other screen element such as highlighting) along a menu on the display screen. Accordingly, the cursor is moved on an item-by-item basis (e.g., from item 100 to item 102 in menu 92 shown in FIG. 4) by each pressing action on the pointing device. Similarly, a particular item/function on the menu (e.g., item 102 of menu 92 in FIG. 4) is selected for activation by a longer duration pressing action on the pointing device. In another embodiment, sliding movements at the pointing device produce movement of the cursor from item to item on the menu, while pressing movements at the pointing device select an item/function for activation.

In another embodiment, both scroll parameter 284 and rocker switch parameter 286 are enabled. In this arrangement, scroll parameter 284 enables sliding movements at a pointing device to generally correspond to item-by-item movement across a menu (e.g., from item 100 to item 102 in menu 92 shown in FIG. 4), with each scrolling movement corresponding a discrete single step movement on a menu (e.g., menu 92). Rockerswitch parameter 286 enables pressing action at the pointing device to generally correspond to selection of a highlighted menu item (identified via operation of scroll parameter 284) for activation.

Trackball parameter 288 enables use of a pointing device in a trackball function, in which relative movements at a portion of the pointing device cause a cursor to move in a corresponding direction, duration, and speed across a display screen associated with the pointing device. A trackball mode of operation is substantially the same as a mouse mode of operation enabled via mouse parameter 280. When the sliding movements of the pointing device cease, then the trackball parameter 288 causes the cursor on the display screen to remain stationary.

Touchpad parameter 290 enables use of a pointing device in a touchpad function, in which relative movements across a surface (e.g., sliding action) of the pointing device cause a cursor to move in a corresponding action across a display screen associated with the pointing device. Touchpad parameter 290 enables a function substantially the same as mouse parameter 280.

Keypad parameter 292 enables use of a pointing device in a keypad function, in which relative movements across the surface (e.g., sliding action) or relative movements against the surface (e.g., pressing action) of the pointing device cause movement between different keys of a keypad (e.g., keys 95 of keypad 94 in FIG. 4) and/or selection of a key of multiple keys of a keypad on a display screen associated with the pointing device. In other words, keypad parameter 292 enables the pointing device to operate a graphical keypad on a display screen via pressing action or sliding action at the pointing device.

Touchscreen parameter 296 with stylus parameter 297 enables use of a pointing device in a touchscreen/stylus function, in which relative movements across the surface (e.g., sliding action) or relative movements against the surface (e.g., pressing action) of the pointing device cause dragging type movements or activation type functions on a display screen associated with the pointing device. In other words, touchscreen parameter 296 with stylus parameter 297 enables the pointing device to like a stylus for a touchscreen in which pressing action at the pointing device generally corresponds to selecting an item as would occur with a stylus and sliding action at the pointing device generally corresponds to positioning a stylus-type cursor on the display screen at desired location for activating a function at that location via a pressing action at the pointing device.

Hybrid parameter 298 enables use of one or more parameters of input mode module 252 in various combinations, in which the different parameters are enabled sequentially or simultaneously.

Parameters of input mode module 252 operate together in many combinations, including those previously described, as well as other desirable combinations recognized by those skilled in the art.

FIG. 7 also shows interface style module 254 which enables setting a pointing device in one or more modes of operation suited to a particular user interface. As shown in FIG. 7, interface style module 254 comprises menu parameter 300, keypad parameter 302, map parameter 304, gaming parameter 306, and desktop parameter 308.

In one embodiment, menu parameter 300 enables setting a pointing device for use in a menu mode in which a cursor (or other graphical indicia) opens, highlights, and/or selects items in one or more menus. Menu parameter 300 uses one or more parameters 280-298 from input mode module 252, such as rockerswitch parameter 286, scroll parameter 284, mouse parameter 280, etc. to enable the pointing device to direct menu-driven use of a host electronic device associated with the pointing device.

In one embodiment, keypad parameter 302 enables a pointing device to operate a host device or an application of the host device as a keypad by using one or more parameters 280-298 from input mode module 252. Map parameter 304 enables a pointing device to operate a host device or an application of the host device as a map navigator by using one or more parameters 280-298 from input mode module 252. Map parameter 304 enables the pointing device to control zooming in or zooming out on a map on a display screen, as well as guiding directional shifting, such as shifting toward an east (or west, north, or south) portion of a map. Other functions directed via map parameter 304 include highlighting a road to be traveled, a territory to be occupied, etc. These functions, and other functions related to mapping are controlled via pointing device with map parameter 304. Map parameter 304 optimizes between different modes of operation (represented via parameters 280-298 of input mode module 252) of the pointing device to carry out these functions.

In one embodiment, gaming parameter 306 enables pointing device to operate in a gaming mode, relying on one or more modes of operation of pointing device such as joystick parameter 282 (e.g., joystick mode), mouse parameter 280, and/or rockerswitch parameter 286. In one embodiment, operation via joystick parameter 282 enables typical joystick-type control via pointing device while operation via mouse parameter 280 and/or rockerswitch parameter 286 enable mouse-like or rockerswitch-like control to enable data entry or features selection. Of course, other parameters 280-298 of input mode module 252 suited to a gaming function are designated as part of gaming parameter 306 as appropriate.

In one embodiment, desktop parameter 308 enables pointing device to operate in a desktop mode, substantially the same as one would expect for a pointing device operating via mouse parameter 280, scroll parameter 284 or touchscreen parameter 296 of input mode module 252.

Accordingly, interface style menu 254 enables use of pointing device in different modes of operation as determined by one or more styles of user interfaces (specified via parameters 300-308).

FIG. 7 also shows event module 356 which enables one or more different events to trigger a switch between different modes of operation for pointing device. As shown in FIG. 7, event module 256 comprises pressure parameter 320, duration parameter 322, speed parameter 324, distance parameter 326, direction parameter 328, and position parameter 330. Pressure parameter 320 enables switching modes of operation for a pointing device based on a magnitude or rate of increase/decrease of pressure related to a stationary pressing action or a sliding and pressing action at the pointing device. Duration parameter 322 enables switching modes of operation for a pointing device based on a duration of a sliding action, a duration of a pressing action, a duration of a lack of sliding or pressing action, or movement indication behavior at a portion of the pointing device. An additional example for triggering a switch include a duration of maintaining a finger or puck at a particular position of a base surface of a pointing device.

Speed parameter 324 enables switching modes of operation of a pointing device based on a magnitude or rate of increase/decrease of speed related to a pressing action and/or a sliding action at the pointing device. Distance parameter 326 enables switching modes of operation of a pointing device based on a distance of a sliding action (or other movement indicating behavior) at the pointing device while direction parameter 328 enables switching modes of operation of a pointing device based on a direction of a sliding action (or other movement indicating behavior) at the pointing device. Position parameter 330 enables switching modes of operation of a pointing device based on a position of sliding action and/or on a position of pressing action at the pointing device.

In one embodiment, two or more parameters 320-330 of event module 256 are combined to act together to enable switching modes of operation of a pointing device.

FIG. 7 also shows trigger module 258 which enables control over which parameter(s) trigger switching between different modes of operation of a pointing device. As also shown in FIG. 7, trigger module 258 comprises event type parameter 350, threshold parameter 352, application parameter 354, dynamic parameter 356, manual parameter 358, and user profile 360. Event type parameter 350 enables one or more parameters 320-330 of event module 256 to trigger a switch between different modes of operation of a pointing device. Threshold parameter 352 enables selection of a threshold of sliding action, pressing action, or other action/inaction at the pointing device to determine whether a switch of mode of operation for the pointing device is triggered. Threshold parameter 352 sets a threshold for triggering as a magnitude of sliding or pressing action via magnitude parameter 370, a duration of sliding or pressing action via duration parameter 372, and/or a frequency of sliding or pressing action via frequency parameter 374. The threshold is set for any one or more of parameters 320-330 of event module 256.

Application parameter 354 enables a type of application, such as word processor, games, web browser, to trigger a switch between different modes of operation of a pointing device. In one embodiment, the switch is triggered based on an initiation, termination, or pause of a single application. For example, an initiation of use of a gaming application on a host electronic device, a mode of operation for the pointing device can switch from a default mouse-type mode to a gaming mode. In another embodiment, the switch also is triggered upon a user switching between use of two active applications, such as switching between use of an active word processor (using a mouse-type mode) and an active game (using a joystick-type mode).

Dynamic parameter 356 of trigger module 258 enables switching between different modes of operation for pointing device dynamically. In one embodiment, a mode of operation for the pointing device is chosen automatically from among several modes of operation as the user operates the host electronic device via the pointing device with switching between different modes of operation occurring transparently to the user and based on criteria of mode manager 250, such as an event (via event module 256) or application (via application parameter 354).

In contrast, manual parameter 358 of trigger module 258 enables a user to manually control switching between different modes of operation for the pointing device so that switching occurs only at the direct control of the user of the host electronic device.

User profile 360 of trigger module 258 enables a user to set preferences for storing in memory 260 regarding which events trigger switching modes of operation, regarding a threshold for switching, regarding which applications cause switching, etc. Accordingly, as each unique person uses a host electronic device, that person's preferences for switching between different modes of operation for the pointing device are employed.

Memory 260 comprises firmware, hardware, internal and/or external media devices used to mode manager 250 and all of the values or settings of the parameters of mode manger 250.

Accordingly, mode manager 250 enables operating a pointing device within a framework that is responsive to conditions, events and/or applications of a host electronic device and/or that is responsive to preferences of the user.

FIG. 8 is a flow diagram of a method 400 of managing modes of operation for a pointing device, according to one embodiment of the invention. In one embodiment, method 400 is carried out via pointing device 10, 150 and/or mode manager 250, previously described in association with FIGS. 1-7 while in other embodiments, other pointing devices and associated software perform method 400.

As shown in FIG. 8, at 402 method 400 comprises operating a pointing device in a first mode, such as a mouse mode, joystick mode, etc. At 404, a parameter related to the pointing device is identified or detected. In one embodiment, the parameter evaluated at 406 is any one or more of parameters 320-330 of event module 256, parameters 300-308 of interface style module 254, and/or parameters 354-360 of trigger module 258.

At 406, a query is made regarding whether a value or aspect of the parameter meets a predetermined criteria. If the criteria are not met, then the pointing device continues operation in the first mode, as represented at 408. If the criteria are met, then at 410 the mode of operation for the pointing device is changed from the first mode to a second mode.

In one embodiment, method 400 comprises a feedback pathway 420 in which the second mode of operation is reset to be designated a first mode of operation for the pointing device, so that the method is repeatable in an iterative fashion during continued use of the pointing device.

In one embodiment, method 400 is in automatic and continuous operation during operating of the pointing device and/or host electronic device while in another embodiment, a user enables method 400 for operation or non-operation regarding the pointing device.

Embodiments of the invention are directed to enabling switching between different modes of operation for a pointing device. The particular mode of operation for the pointing device is selected according to the kinds of uses of the pointing device (and host electronic device), events occurring during use of the pointing device, etc. In short, modes of operation for a pointing device are changed as needed or desired to optimize use of the pointing device over a range of conditions, events, users, applications, etc.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A portable electronic device comprising:
a pointing device configured to detect relative movement at a portion of the pointing device;
a manager configured to determine a mode of operation for the pointing device from among a first mode of operation and a second mode of operation based on a parameter associated with the portable electronic device.

2. The portable electronic device of claim 1 wherein the portion of the pointing device comprises a base surface and the pointing device is configured to detect relative movement via:
the base surface;
a moveable puck configured to move over the base surface within a puck field of motion; and
a position detector configured to identify a position of the puck.

3. The portable electronic device of claim 1 wherein the pointing device comprises at least one of a touch pad device, a mouse, a joystick, a rockerswitch device, a scroll wheel device, and a touchscreen.

4. The portable electronic device of claim 1 wherein the parameter comprises a status of an application of the portable electronic device.

5. The portable electronic device of claim 4 wherein the status of the application comprises:
an initiation of an application of the portable electronic device;
a termination of an application of the portable electronic device; and
a switch between two different applications of the portable electronic device.

6. The portable electronic device of claim 1 wherein the parameter comprises a first parameter associated with relative movement at the portion surface of the pointing device, the first parameter including at least one of a pressure, a direction, a speed, a position, a duration, and a distance.

7. The portable electronic device of claim 6 wherein the parameter comprises comparing at least one of a duration, a frequency, and a magnitude of the first parameter relative to a threshold.

8. The portable electronic device of claim 7 wherein the magnitude of the first parameter comprises the magnitude of distance of relative movement at the portion of the pointing device including a first magnitude of relative movement associated with the first mode of operation and a second magnitude of relative movement associated with the second mode of operation.

9. The portable electronic device of claim 6 wherein position of relative movement is adjacent an edge of the puck field of motion.

10. The portable electronic device of claim 1 wherein the manager comprises a controller and an application operating on the portable electronic device determines the mode of operation for the pointing device, via the controller of the pointing device, from among a plurality of modes of operation wherein the plurality of modes of operation includes at least the first mode and the second mode.

11. The portable electronic device of claim 1 wherein the parameter comprises at least one of a user profile and an interface style including at least one of a menu style, a keypad style, a map style, a gaming style, and a desktop style.

12. The portable electronic device of claim 1 wherein the parameter comprises an input mode comprising at least one of a mouse mode, a joystick mode, a scroll mode, a rockerswitch mode, a trackball mode, a touchpad mode, a keypad mode, a touchscreen mode, a stylus mode, and a hybrid mode.

13. The portable electronic device of claim 1 comprising at least one of a phone, a portable audio device, a camera, a personal digital assistant, a universal remote, a handheld computer, and a handheld global positioning satellite device.

14. A pointing device comprising:
a base surface;
a moveable puck configured to move over the base surface within a field of motion constrained by a recentering mechanism;
a position detector configured to identify a position of the puck; and
a mode switcher in communication with the position detector and configured to direct operation of the pointing device in at least one of a first mode and a second mode based on a parameter associated with the pointing device.

15. The pointing device of claim 14, wherein the first mode of operation comprises a mouse mode of operation, the second mode of operation comprises a joystick mode of operation, and the parameter comprises the position of the puck relative to an edge of the puck field of motion wherein the mode switcher causes operation of the pointing device in the first mode when the puck is away from the edge of the field of motion and in the second mode when the puck is adjacent the edge of the field of motion for a predetermined period of time.

16. The pointing device of claim 14, wherein the parameter comprises a type of application operating at a host electronic device supported by the pointing device.

17. The pointing device of claim 14 wherein the parameter comprises exceeding a threshold of at least one of a magnitude, a duration, and a frequency of a type of movement of the puck relative to the base surface.

18. A computer readable medium having computer-executable instructions for performing a method of managing modes of operation for a pointing device, the method comprising:
monitoring relative movement of a portion of a pointing device that generates movement data; and
switching between a first mode of operation of the pointing device and a second mode of operation of the pointing device upon detecting an event associated with the pointing device.

19. The medium of claim 18 wherein switching between the first mode and the second mode comprises setting the event as a change in an application of a portable electronic device supported by the pointing device.

20. The medium of claim 19 wherein monitoring relative movement of the pointing device comprises:
monitoring movement of a puck of a pointing device across a base surface of the pointing device within a puck field of motion via a position detector of the pointing device, the position detector configured to identify a position.
